(19) United States
(12) Patent Application Publication
(10) Pub. No.: US 2008/0163734 A1
(43) Pub. Date: Jul. 10, 2008

(54) DIVIDING APPARATUS FOR AUTOMATIC NOTCHING PRESSES WITH A DIRECT DRIVE

(75) Inventor: Norbert KONRAD, Weingarten (DE)

Correspondence Address: BURR & BROWN, PO BOX 7068, SYRACUSE, NY, 13261-7068, US

(73) Assignee: Mueller Weingarten AG, Weingarten (DE)

(21) Appl. No.: 11/972,665

(22) Filed: Jan. 11, 2008

Related U.S. Application Data
(63) Continuation of application No. PCT/DE2006/001055, filed on Jun. 21, 2006.

(30) Foreign Application Priority Data
Jul. 12, 2005 (DE) 10 2005 032 902.0

(51) Int. Cl. B26D 7/06

(52) U.S. Cl. 83/733

(57) ABSTRACT

A dividing apparatus for an automatic notching press is proposed in which the drive is operatively connected directly, without a reduction gear unit, to the dividing device by means of a torque motor.

### CROSS REFERENCE TO RELATED APPLICATIONS

This application is a continuation of International Application No. PCT/DE2006/001055, filed Jun. 21, 2006, and German Application No. 10 2005 032 902.0, filed Jul. 12, 2005, the entireties of which are incorporated herein by reference.

### FIELD OF THE INVENTION

The invention relates to a dividing apparatus for automatic notching presses with a direct drive.

### BACKGROUND OF THE INVENTION

The economic production of rotor and stator laminations for electric motors is achieved using notching punches when small and medium series are required. There are ever-increasing market demands for quality and productivity. The rotor and stator notches are cut out individually on a notching punch. Given a suitable design of the tools it is possible for the rotor to be separated from the stator and/or for the outside diameter to be trimmed at the same time as the stator is being notched.

Tool and machine investments are low in the case of this method. Changeover to other sizes can take place quickly and simply. In principle, a distinction can be drawn between two type series of notching punches. The two type series are distinguished primarily in terms of the drive of the dividing apparatus. A distinction can be drawn here between the mechanical and the numerical drive of the dividing apparatus. In the case of notching punches with a mechanical dividing apparatus drive, the dividing device is driven synchronously from the eccentric shaft of the machine to a cam indexing mechanism via a bevel gear unit. This positive mechanism ensures an exact notch division over the entire stroke number range. Owing to its particular kinematics, the cam indexing mechanism converts the rotary movement of the eccentric shaft into a step-by-step movement of the dividing shaft. The nonvariable basic division of the step-by-step rotary movement on the drive shaft is adapted to the desired notch division by the exchange of change wheels. DE 16 27 227 B describes such a mechanically driven dividing device. Use is also made of this constructive solution in DE 37 31 102 C2.

In the case of notching punches with a numerical dividing apparatus drive, the dividing device is driven by a three-phase a.c. motor having a backlash-free reduction gear unit. The exact positioning is achieved via a rotation sensor for actual value detection in an NC position control loop. The numerically controlled dividing drive is particularly used for small series in which frequent changeovers are required. No change wheels for different notch division have to be kept in stock. A further advantage is that a large notch number range can be covered. The “Handbuch der Umformtechnik” [Manual of Forming Technology], Schuler 1996, page 300, illustrates and describes a notching punch in which the dividing apparatus has a numerical drive.

A disadvantage with this configuration is the high structural outlay and the associated high costs. Owing to the positioning accuracies demanded of the dividing device, very high quality requirements must be placed on the reduction gear unit, something which in turn leads to an increase in the costs. Furthermore, by virtue of the reduction gear unit, a numerical dividing apparatus requires a large overall space.

A further disadvantage of the above-described numerically controlled dividing apparatus with reduction gear unit is that, when there are greatly differing foreign masses, i.e. greatly varying blank sizes, the required positioning results can be achieved only with a high outlay on adaptation owing to the differing masses which have to be accelerated.

### SUMMARY OF THE INVENTION

Taking the prior art as a starting point, the object on which the invention is based is to develop a dividing apparatus for notching punches with NC-controlled electric drive that has a small overall size on the one hand and ensures a high degree of positioning accuracy on the other hand. In particular, this is to be brought about using a cost-effective solution.

The core idea on which the invention is based is to position the rotary or positioning drive directly on the rotating holder of the dividing apparatus. The use of a torque motor makes it possible not only to satisfy the requirements placed on the dynamics but also those placed on positioning accuracy. In the case of the dividing apparatus according to the invention, the drive motor, preferably a torque motor, is positioned so that the drive shaft of the motor is aligned with the axis of rotation of the dividing apparatus. The advantage over known solutions is that a reduction gear unit can be completely dispensed with. This is particularly of advantage for the positioning result, since the production tolerances of the reduction gear unit components are no longer present and are thus also no longer able to negatively affect the positioning accuracy. The drive shaft, which connects the motor to the blank holder, can be embodied either as a solid shaft or as a hollow shaft. The hollow shaft has the advantage that media lines, such as, for example pneumatic lines, hydraulic lines or electric cables, for supply of active elements, such as, for example, clamping devices or position sensors, can be passed through the hollow space.

A further advantage of the dividing apparatus according to the invention is a considerable reduction in the manufacturing costs owing to the reduction in the number of components used. In particular, the gearwheels of the reduction gear unit, which are cost-intensive owing to the narrow production tolerances, can be dispensed with. Advantageous too is the considerably reduced space requirement resulting from the omission of the reduction gear unit, which in known solutions is generally built on in front of the notching punch and thus further impedes accessibility, for example for setting-up purposes or for maintenance work.

A further advantage of the dividing apparatus according to the invention over the prior art is in the improved adaptation of the dividing device to greatly differing foreign masses, i.e. blanks having greatly differing diameters. The direct, rigid coupling of the rotary motor to the dividing device means that setting-up operations are virtually avoided. Optionally, use can also be made of torque motors in which the stator can be integrated directly into the press body.

### BRIEF DESCRIPTION OF THE DRAWINGS

Further details and advantages of the invention will become apparent from the exemplary embodiment represented by way of a FIGURE.

FIG. 1 shows a schematic representation of the notching punch and of the dividing apparatus with a direct drive.

### DETAILED DESCRIPTION OF THE INVENTION

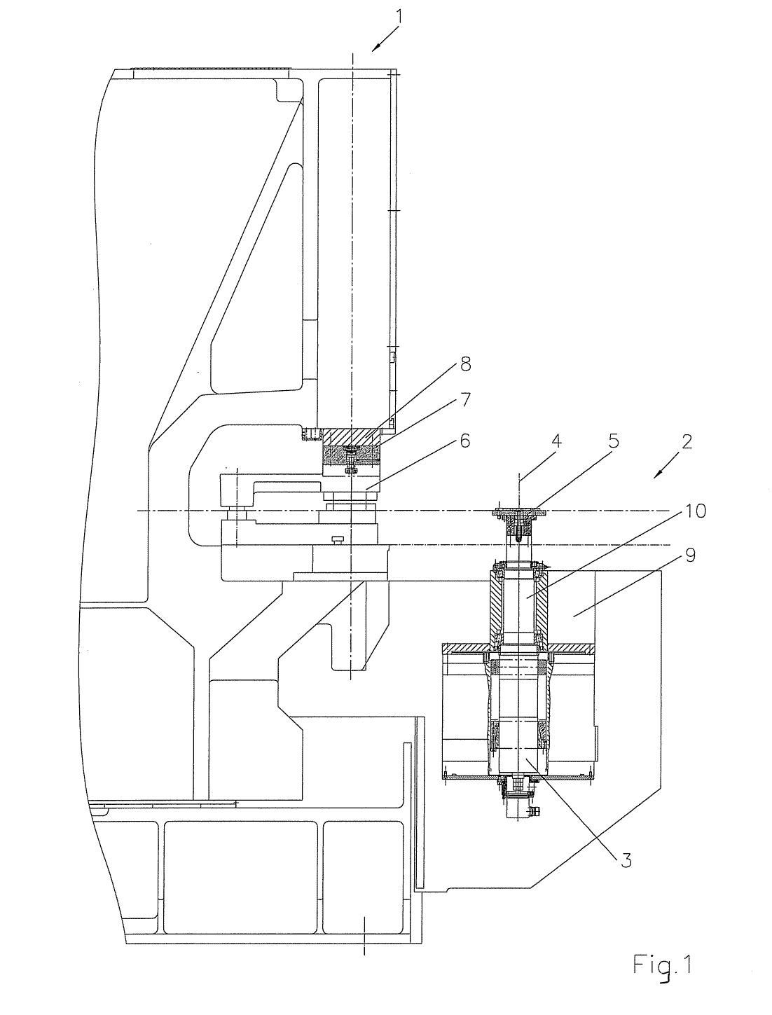

FIG. 1 shows a schematic representation of a notching punch 1 and a dividing apparatus 2 built thereon. The dividing apparatus 2 is driven by a torque motor 3. What characterizes the arrangement represented is that the torque motor 3 has its motor shaft 10 arranged in alignment with the blank holder 5 along an axis 4. The blank holder 5 has the task of securing a round blank (not shown here) during the punching operation and of advancing it cyclically about the axis of rotation 4 between the punching operations. The blank is thereby guided through between the upper part and lower part of a notching tool 6. The upper part of the notching tool 6 is fixedly connected via a tool holder 7 to a ram 8. During each stroke of the ram 8, a blank to be notched is advanced cyclically by the dividing apparatus 2 by a defined circular arc segment. Since the torque motor 3 is supported on the press body 9 and is operatively connected directly to the blank holder 5 via the motor shaft 10 along an axis 4, very high degrees of accuracy can be achieved in the cyclic rotation of the blanks.

The invention is not limited to the exemplary embodiment which has been represented and described. It also covers all developments by a person skilled in the art within the concept according to the invention.

### LIST OF REFERENCE NUMBERS

1 notching punch
2 dividing apparatus
3 torque motor
4 axis of rotation
5 blank holder
6 notching tool
7 tool holder
8 ram
9 press body
10 motor shaft

1. A dividing apparatus for automatic notching presses for cyclically rotating and positioning a preferably round blank which is guided between an upper tool and a lower tool between two punching operations, wherein a motor is operatively connected directly, without intermediate gearing, to a blank holder via a motor shaft.

2. The dividing apparatus as claimed in claim 1, wherein the axis of rotation of the motor and of the motor shaft is aligned with the axis of rotation of the blank holder.

3. The dividing apparatus as claimed in claim 1, wherein the motor is an NC motor.

4. The dividing apparatus as claimed in claim 1, wherein the motor is a torque motor.

5. The dividing apparatus as claimed in claim 1, wherein the motor shaft is designed as a solid shaft.

6. The dividing apparatus as claimed in claim 1, wherein the motor shaft is designed as a hollow shaft.
